(19) United States
(12) Patent Application Publication
(10) Pub. No.: US 2011/0178940 A1
(43) Pub. Date: Jul. 21, 2011

(54) AUTOMATED ASSESSMENT CENTER

(76) Inventors: Matt Kelly, Kernersville, NC (US); Gary Patrick, Denver, NC (US); Slobadan Srbinovski, Beavercreek, OH (US)

(21) Appl. No.: 13/009,360

(22) Filed: Jan. 19, 2011

Related U.S. Application Data
(60) Provisional application No. 61/336,252, filed on Jan. 19, 2010.

(51) Int. Cl. G06Q 10/00

(52) U.S. Cl. 705/321

(57) ABSTRACT

A web based Assessment Center system that imposes a prescribed workflow and facilitates defined interactions between the various participants implementing the Assessment Center method using portal technology. The system relies on a hub-and-spoke web-based client/server architecture, and a software foundation comprising an open-architecture modular array of web-based software for data collection and exchange between the various participants. The software modules include a Role profile module by which a customer can specify a freeform customer role profile, a Job Analysis module for distilling suitability ranking factors from the customer's free form Role profile, a Proctor Module for online testing, a Simulation Module for recording video simulations, and a Scoring Module for standardizing multiple Assessor scoring of the recorded video simulations and consolidation of the online test scores and simulation scores into a Data Map for collective decision-making. An integrated Video Training Module for training and certification of Assessors.

### CROSS REFERENCE TO RELATED APPLICATIONS

The present application derives priority from U.S. Provisional Patent Application 61/336,252 filed on 19 Jan. 2010 which is incorporated herein by reference.

### BACKGROUND OF THE INVENTION

1. Field of the Invention

The present invention relates generally to systems for assisting managers, stakeholders, and shareholders who deal with selection and development of people; specifically decision makers in human resources, marketing, supply chain, education administration, and shareholder advocates. The invention more specifically is an automated assessment center including a software-implemented workflow process atop a distributed client-server architecture that services the needs described above in a cost effective way.

2. Description of the Background

Contrary to its connotation, the term “assessment center” is not a physical location at all, but is instead a formalized methodology for objectively observing and measuring how people actually perform in situations relevant to a specific job or task, and for evaluating those observations/measurements for people selection, development or otherwise.

In the United States assessment center methodology has been used since at least World War II, where the Office of Strategic Studies employed them to select spies. AT&T adapted the methodology for management selection in 1956, and was followed by many other companies including Standard Oil, IBM, Sears and General Electric. Since that time the use of assessment centers has spread to many different organizations to assess individuals for many diverse types of jobs, and today a well designed Assessment Center is commonly accepted to be the most effective tool available for assessing individuals in both individual and group based environments for selection or development.

Despite the rapid growth in the use of the assessment center method in recent years across a broad array of industrial, educational, military, government, law enforcement, and other organizational settings, devotees of the method have voiced the need for standards or guidelines for users of the method. In response, the 3rd International Congress on the Assessment Center Method (Quebec 1975), endorsed a first set of guidelines, and these have evolved to the current guidelines adapted at the 34th International Congress on the Assessment Center Method (Washington, D.C., USA 2008), namely the International Task Force on Assessment Center Guidelines (ITFACG) of 2009.

A modern assessment center comprises a standardized evaluation of behavior based on multiple inputs. Multiple trained observers and techniques are used. Judgments about behaviors are made, in large part from specifically developed assessment simulations. The assessor judgments are pooled by a standardized (sometimes statistical) integration process, and decisions are made. Assessment Centers are most often used for employee selection, promotion of supervisors and managers, sales assignments, and human resource diagnosis. However, they are also used for ancillary purposes such as internal training & development needs, employee skill enhancement through simulations, and for outplacement. Use in other organizational disciplines like supply chain and marketing, as well as other industries like education, and investor relations for use in admissions and board selection respectively, are innovative uses of Assessment Center techniques and methods.

The use of the word “candidate” throughout refers to the general uses of this invention which include performing new-hire and incumbent employee assessment, evaluation and selection of internal employees for succession planning and top grading, vendor representative assessment for vendor evaluation and selection, and marketing focus group assessment. In a typical Assessment Center workflow, candidates will participate in a series of simulation exercises that replicate “on-the-job” situations. Trained assessors will observe and document the behaviors displayed by the participants. The assessors individually write evaluation reports, documenting their observations, and the documentation is combined through a consensus-building process. Each participant receives objective performance feedback.

The ITFACG requires that an Assessment Center have the following components:

1. Job Analyses to determine desired behaviors that are required. These desired behaviors need to be determined valid with respect to job performance. Content-, criterion-, and construct-based validation-type strategies can be employed.

2. Behavioral Classification to categorize behaviors, beliefs, and attitudes into groups or dimensions (knowledge, skills, abilities, values, etc.)

3. Assessment Techniques that will be used to measure the behaviors, beliefs, and attitudes as determined by the Job Analysis

4. Multiple Assessments must be used to provide cross validation

5. Simulations are a type of assessment that will be used to observe behavioral responses to job-related situations; the simulations must be relevant to behaviors determined through the job analysis and validation procedures and the behavioral classification system.

6. Assessors are required to observe simulations; multiple raters are required for each simulation

7. Assessor Training with raters meeting prerequisite reliability scores prior to participation in the assessment center

8. Recorded Behavior during the assessment center process must follow a systematic procedure that assures consistent, accurate, and standardized assessment procedures that are valid

9. Data Integration will be based on the pooling of information from assessors and/or through a validated statistical integration process.

Though many organizations adhere to the above-described requirements, they are limited to on-site assessment and evaluation. Assessors meet face-to-face with the individuals being assessed, assessors meet face-to-face among themselves, and the assessors provide written recommendations to the organization and the prospective candidate. This imposes travel requirements to the traditional on-site assessment centers, which adds time and expense, and often limits the available pool of candidates. Furthermore, traditional on-site assessment centers often lack the degree of standardization necessary to provide consistent quality of service.

Distributed computing and communication architectures have largely eroded the need for face-to-face communications and workflows in other business contexts, but these have not made inroad to the Assessment Center due to the complexities involved with remote performance assessments where manifest behavior is measured.

As a consequence, there is presently a great need for a distributed system that is easily accessible by the various parties to the Assessment Center approach, that both facilitates information gathering, integration, and analysis, and implements an ITFACG-guideline-compliant remote, web-based Assessment Center for performing selection, assessment, evaluation and promotion using internet-based technology as a communication vehicle.

### SUMMARY OF THE INVENTION

It is, therefore, a primary object of the present invention to provide an automated assessment center that implements an ITFACG-guideline-compliant remote Assessment Center workflow using a web-based software suite and distributed computer architecture to facilitate information gathering, integration, and analysis, and implements the foregoing to perform selection, assessment, evaluation and promotion. The embodiment of this invention is intended for both server-client application and mobile device application.

In accordance with the foregoing object, the present invention is a web-based Assessment Center system that brings together the various participants, facilitates communication, and imposes a prescribed workflow with defined interactions between the participants during information gathering, integration, and analysis though the Assessment Center method.

The system relies on a hardware foundation comprising a hub-and-spoke web-based client/server architecture, and a software foundation comprising an open-architecture modular array of web-based software for data collection and exchange between the various participants. A URL-based (uniform resource locator) web portal is established for each of the participants. In addition, a hierarchical permissions scheme is assigned including administrator and individual users permissions. The participants use one or more client side computer stations for accessing their assigned web portal. The web portal includes hyperlinks to a plurality of index-tabbed webpages each including content for guiding the respective participants through all of the steps of a prescribed workflow for standardized implementation of the Assessment Center method.

The system is herein described in the context of an application service provider (ASP) distribution model. An ASP is a vendor that supplies software applications and/or software services to customers over the Internet. The software applications and data are supported and maintained by the ASP on servers in the ASP's client/server architecture, and the ASP handles the network maintenance and administration. Subscribers access their applications and related data via the Internet, Virtual Private Networks (VPN), dedicated leased lines (e.g., a T-1 line), or dial-up modem connections. The above outlined system architecture can also be applied using mobile display and coding technologies for use on mobile devices.

In addition to the workflow guidance, the participants also have access (through their web portals and based on the permissions scheme) to the server-hosted software modules which facilitate data exchange amongst the various participants, as well as various third party applications used by those participants. The software modules cooperate with each other to collectively provide each participant all essential communication, data analysis and workflow management and tracking tools needed to complete their normal project workflow in a more convenient, timely and error-free manner.

The software modules are transparent to the end user and require no ASP programming. Specifically, the software modules include a unique Job Analysis module by which a customer can specify a customer role profile based on unique job data, without ASP programming or assistance. The Job Analysis module determines and validates the suitability ranking factors from the customer's free-form data input. The modules also include a Simulation Module by which on-line simulations are remotely recorded using live human Assessors in the video simulations (verse taped or staged simulations), and are then distributed to all Assessors for evaluation. An integrated Video Training Module facilitates the training and certification process for Assessors themselves.

For a more complete understanding of the invention and its objects and advantages, refer to the remaining specification and to the accompanying drawings.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a diagram of the hub-and-spoke architecture which shows the principle participants in an Assessment Center environment.

FIG. 2 is a flow diagram illustrating the stepwise workflow according to the present invention.

FIG. 3 is a perspective drawing illustrating the participants performing the workflow as in FIG. 2.

FIG. 4 is a screen print of the Customer 40 online Job Analysis form.

FIG. 5 is a screen print of an exemplary Job Model.

FIG. 6 is a screenshot of the Assessment Interface Homepage.

FIG. 7 is a screenshot of a Customer Situation Role Play which the Assessor views and uses the scoring tools (drop down scoring menus) to facilitate data entry of the Assessor's actual assessment.

FIG. 8 is an exemplary screenshot of the Assessee performance Data Map.

### DETAILED DESCRIPTION OF THE PREFERRED EMBODIMENT

The present invention is an automated assessment center including a software-implemented workflow and distributed client-server architecture for assisting human resource personnel in performing new-hire assessment, evaluation and selection, as well as internal training. The system brings together all principle players in an Assessment Center environment, presents a user-specific graphical interface to each, plus the shared software guidance and analytical tools to implement a prescribed Assessment Center workflow in full compliance with ITFACG guidelines. Moreover, the system monitors progress toward fulfillment of the workflow, and generates feedback status reports. Thus, the system administers a turnkey Assessment Center solution.

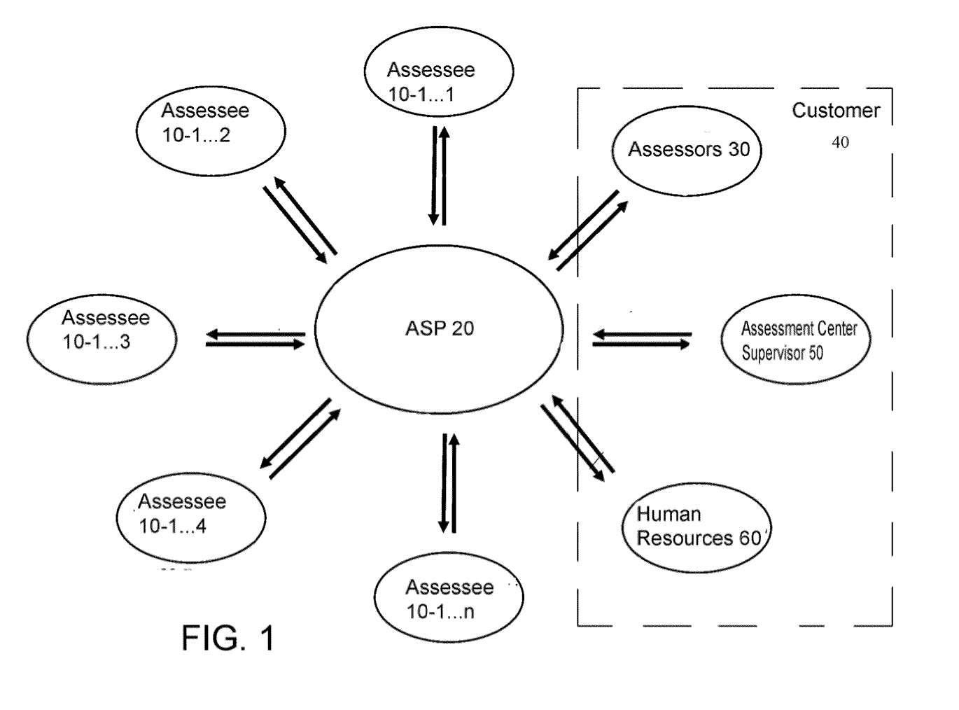

As shown in FIG. 1, the principle participants in an Assessment Center environment may include one or more of the following: the Customer 40 (an employer seeking to identify employee candidates' individual strengths and development needs); application service provider (ASP) 20 (third party administrator of the present system); Assessors 30-1 . . . n (customer employees or contractors responsible for the assessments); Assessees 40-1 . . . n (internal or external job candidates); one or more Assessment Center Supervisors 50 (customer employee(s) responsible for process oversight); and Human Resources 60 (customer employee(s) responsible for hiring decisions).

The system is intended for licensed subscription to Customers 40. However, all participants must register for use. The system simplifies data entry, tracking, and assessment based upon role profiles (candidate-selection criteria) inputted by the Customer's Human Resources 60. The software presents a user-specific interface, specific to each type of participant depending on their assigned permissions level, inclusive of a graphical user interface that provides access to the software modules for carrying out their assigned functions and facilitating defined interactions between the participants during information gathering, integration, and analysis.

The system relies on a hardware foundation comprising a hub-and-spoke web-based client/server architecture, and a software foundation comprising an open-architecture modular array of web-based software for data collection and exchange between the various participants, as well as data analytics. A URL-based (uniform resource locator) web portal is established for each of the participants. In addition, a hierarchical permissions scheme is assigned including distinct permissions levels for each type of participant. The participants use one or more client-side devices for accessing their assigned web portal, which devices may include conventional personal computers, cellular phones and personal digital assistants (PDAs), PC Tablets, as well as laptops, PCs, or any other computing device with display and user-input controls.

The web portal includes hyperlinks to a plurality of webpages each including content for guiding the respective participants through all of the steps of a prescribed workflow for standardized implementation of the Assessment Center method.

The system is herein described in the context of an application service provider (ASP) distribution model. An ASP is a third party vendor that supplies software applications and/or software services to customers over the Internet. The software applications and data are supported and maintained by the ASP 20 on servers in the ASP's client/server architecture, and the ASP handles the network maintenance and administration. All other participants (Customers 40; Assessors 30-1 . . . n; Assessees 40-1 . . . n; Assessment Center Supervisor(s) 50; and Human Resources 60) all access their URL and the shared software modules there through using client devices via the Internet using Virtual Private Networks (VPN), dedicated leased lines (e.g., a T-1 line), wireless or dial-up modem connections, etc. One skilled in the art will readily understand that the above outlined system architecture can also be implemented using mobile display and coding technologies for use on mobile devices.

In addition to the workflow guidance, the participants also have selective access (through their web portals, subject to the permissions scheme) to an array of server-hosted software modules that facilitate data exchange amongst the various participants, as well as various third party applications used by those participants. The software modules cooperate with each other to collectively provide each participant all essential communication, data analysis and workflow management and tracking tools needed to complete their normal Assessment Center workflow in a more convenient, timely and error-free manner. The software modules also keep the ASP transparent to the participants. More specifically, the software modules include a unique Job Analysis module by which a Customer 40 can specify a “role profile” which includes candidate-selection criteria in plain-English lay terms, without manual translation or ASP programming. The Job Analysis module validates the criteria inputted by Customer 40 and translates the role profile into a standardized parametric Job Model form. The modules also include a Simulation Module by which simulations using live human Assessors 30 are recorded in digital video format (verse taped or staged simulations), and which distributes the recorded simulations to all Assessors 30-1 . . . n online. In addition, an Integrated Video Training module facilitates the certification process for Assessors 30.

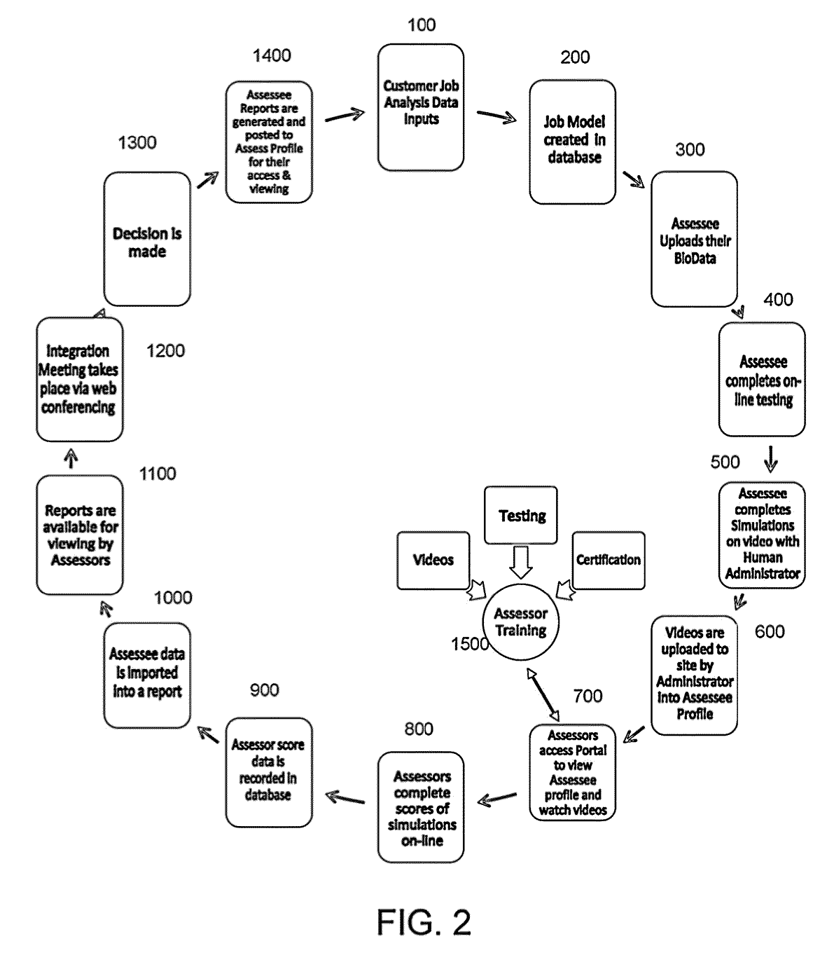

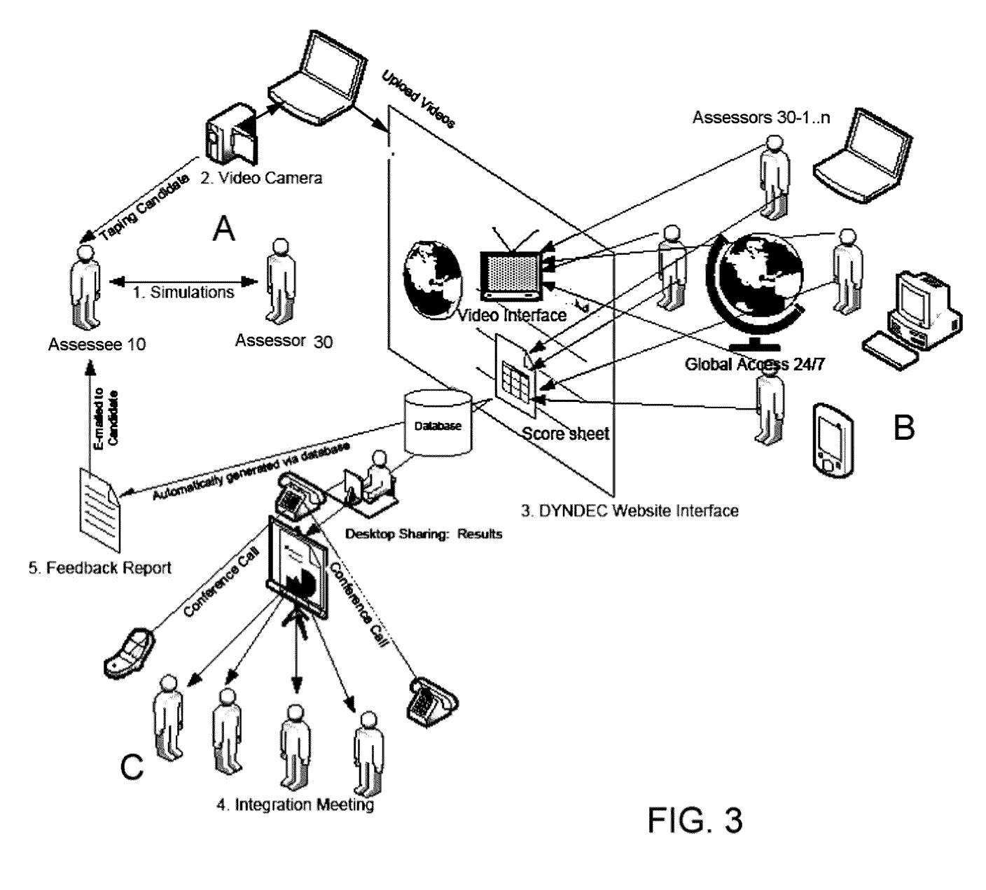

FIG. 2 is a flow diagram illustrating the stepwise workflow according to the present invention, and FIG. 3 is a perspective drawing illustrating the participants performing the workflow as in FIG. 2.

As seen in FIG. 2, at step 100 the Customer 40 (with or without ASP 20 guidance) completes an in-house job analysis by which they analyze the work experience, skills, education and willingness necessary to perform effectively. Customer 40 then logs onto their assigned URL at the ASP 20 website and completes data entry into an online Job Analysis form. The Job Analysis is a systematic study of a particular job to identify the observable work activities, tasks, and responsibilities associated with that job. It identifies the personal qualifications necessary to perform the job and the conditions under which work is performed. The Client may use a variety of established job analysis methods to gather job information inclusive of surveys/questionnaire's and/or observation. For example, there are existing validated survey instruments such as the Professional and Managerial Position Questionnaire (PMPQ) which can be used, or interviews may be conducted of Client job populations by qualified staff such as psychologists, and validated cognitive tests of the client job population may be deployed. The purpose of the job analysis is to ascertain patterns of job-related behavior through data collection and analysis. Once the Customer 40 is logged onto their assigned URL at the ASP 20 website they populate an online Job Analysis form based on the results of their job analysis, which solicits entry of the job type, job description, list of tasks, and desired behaviors that are required for the job.

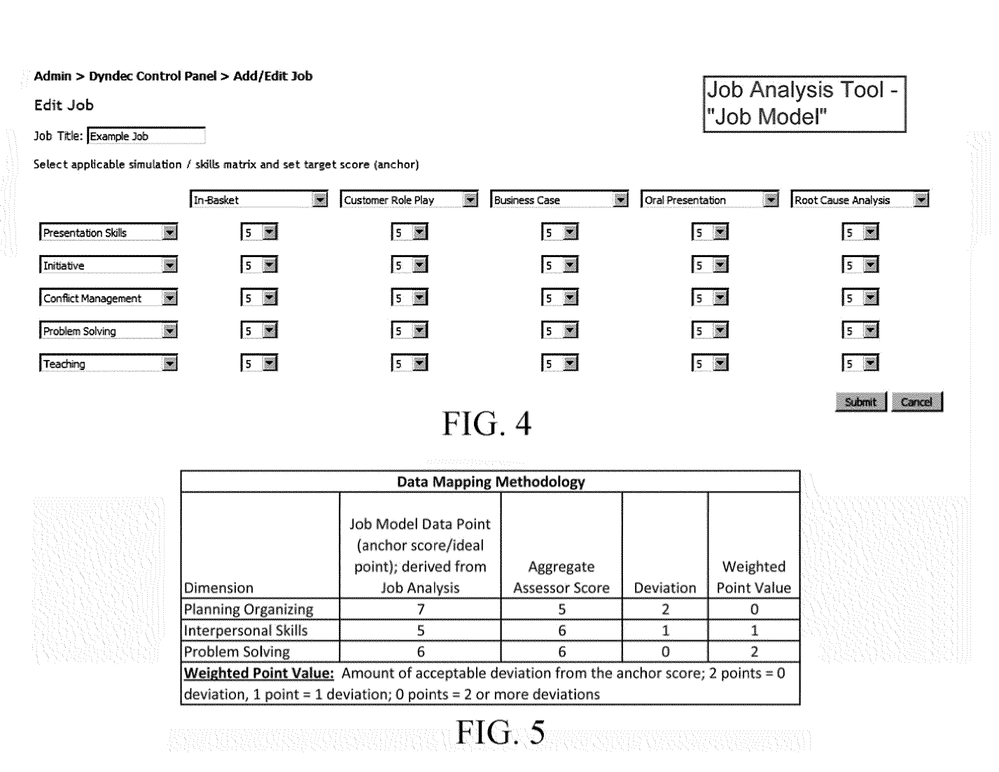

FIG. 4 is a screen print of the Customer 40 online Job Analysis form, which comprises a matrix of drop-down desired behaviors, e.g., all competencies that are required to successfully complete the tasks that are required within the job description. The Job Analysis form solicits desired knowledge, skill and attitude competencies specific to a selected job title (first column), simulation/skills assessments (top row), and standardized rankings (body). Five exemplary competencies are shown, including presentation skills, initiative, conflict management, problem solving, and teaching. Five exemplary assessments are shown, including presentation skills, initiative, conflict management, problem solving, and teaching. The Customer 40 simply selects the relevant competencies from a predetermined selection of categorical competencies associated with the selected job title, selects the relevant assessments from a predetermined selection of assessments likewise relevant to the selected job title, and selects a predetermined target score for each combination (on a predetermined scale of, for example, 1 (lowest) to 5 (highest). The Customer 40 online Job Analysis form forces a standardized quantitative matrix of scoring thresholds from the Customer 40 perspective. This information is transmitted back to the ASP 50 and is stored in the resident database.

The Job Analysis module then validates the criteria inputted by Customer 40, ranks the job-related behaviors, isolates the highest ranked behavioral patterns and quantifies and compiles them into a standardized parametric Job Model as shown in Step 200. As an example, a General Manager's Job Analysis will typically indicate “Leadership” to be to be the most highly ranked behavioral pattern of successful managers. Following Step 200, the Job Model may be appended to reflect a minimum score of 5 for Leadership and an ideal score of 7. All scores are visually presented in the Job Model in relation to thresholds. Specifically, the Job Model comprises a parametric classification of the requisite job skills/competencies, job behaviors, (categorical behaviors, beliefs, and attitudes), and job dimensions (knowledge, skills, abilities, values, etc.) derived from the Customer 40 online job analysis form.

FIG. 5 is a screen print of an exemplary Job Model, which illustrates the compiled ranking of job-related behaviors. Initially, the Job Analysis software module (using content valid measures) validates the data on the Job Analysis form to ensure that the desired behaviors are valid with respect to job performance. Validation may occur using any of a variety of validation strategies including content-, criterion-, and/or construct-based validation-type strategies, expressed as a ruleset for comparison to the Job Analysis form entries. Any Customer 40-inputted standardized competencies/rankings that are not relevant to a particular job title are filtered out. For example, if a desired behavior for a technical writer includes “male gender” (as illustrated) or “oral advocacy” these qualities may be filtered out as incongruous for that categorical job type (also as illustrated). Next, the Job Analysis software module applies a data mapping process to the remaining Job Analysis form entries in order to categorize them and rank the categories by importance. Thus, the five Customer 40-identified competencies: presentation skills (initiative, conflict management, problem solving, and teaching) are mapped by the Job Analysis software module into three categorical job dimensions (Planning, Organizing, Interpersonal Skills) as shown in the first column. The Job Analysis software module then assigns a threshold anchor/ideal point score for each mapped-dimension, which threshold score is likewise derived from the Job Analysis form. These thresholds are set for the purpose of scoring using a standardized scale (i.e. minimum score of 5 on a 10 point scale is acceptable for leadership, 7 is ideal, and greater than 7 is highly desirable). The threshold mapping functions will typically be determined by a team of client subject matter experts and may involve Customer 40 and ASP 20 interaction. The thresholds are appended to the parametric Job Model as shown in Step 200.

As shown in FIG. 5, column 2, the assigned threshold anchor/ideal point scores for the three categorical job dimensions (Planning, Organizing, Interpersonal Skills) are 7, 5 and 6, respectively. These figures are computed as a weighted rank importance for each dimension derived from the standardized quantitative matrix of target scores (1 lowest to 5 highest) entered by the Customer 40 in online Job Analysis form. The Job Analysis software module also assigns a Weighted Point Value (column 5) which represents a permissible deviation from the threshold anchor/ideal point score for each dimension. The Weighted Point Value is a subjective programmed function of the rank importance in view of the threshold anchor/ideal point score for each dimension. The Job Model Data Point Aggregate Assessor Scores (column 3) and Deviation (column 4) are appended based on the results of the assessments (to be described).

Although this parametric classification of the Job Analysis software module is preferably compiled by ASP 20 internally using the Customer 40 inputted data from Step 100, one skilled in the art will readily appreciate that it may alternatively, may be outsourced to a third party provider of job analysis services. There are a variety of third party service providers that provide such classification services.

The rendered Job model is a set of data points which can more easily be used for objective scoring and reporting. For example, a desired behavior for a technical writer may include “grammatical skills” and so this quality is mapped to a graphical model that separates all such qualities into regions of mastery. Next, given a pool of applicants, each applicant will be emailed a link to an assigned URL. Each will log onto their assigned URL at the ASP 20 website and complete individual data entry of biographical information into a BioData form. The BioData information is likewise transmitted back to the ASP 20 and is stored in the resident database as part of an individual profile established for each Assessee 10. This BioData is tied into the concurrent criteria-based validation study, produce content valid patterns, or a construct valid job model the customer might have in the future.

From this pool of registered applicants, each applicant (now Assessee 10) is individually assessed in their locale by a combination of online testing and remote simulations.

With combined reference to FIGS. 2-3, at step 400, the Assessee 40 completes on-line testing. The online testing may comprise any one or more assessments chosen from an array of dynamic simulations (to be described) plus static tests, including cognitive ability tests (written questions or problems to measure ability to learn logic, reasoning, reading comprehension, etc.), personality tests, job knowledge tests (multiple choice questions or essays to evaluate technical or professional expertise and knowledge required for specific jobs or professions), specific biographical data, etc.

There are four scenarios for the individual assessments: 1) a designated Administrator (Assessor or HR Representative) 30 will either travel to the Assessee 10 location with a specially-configured portable computer or mobile device such as Smartphone, tablet, or internet enabled device called a Remote Assessment Center Workstation to test each Assessee's cognition, as well as to deliver the simulation testing described below; 2) the Assessee 10 will travel to the Administrator (Assessor or HR Representative) 30 location and participate in the Assessment Center process using a specially-configured portable computer or mobile device such as Smartphone, tablet, or internet enabled device called a Remote Assessment Center Workstation to test each Assessee's cognition, as well as to deliver the simulation testing described below; 3) the Assessee 10 completes the process from their own locale (i.e. their home) using a specially-configured portable computer or mobile device such as Smartphone, tablet, or internet enabled device called a Remote Assessment Center Workstation, which is sent to their locale, to test each Assessee's cognition, as well as to deliver the simulation testing described below; 4) the Assessee 10 enters the Assessment Center web portal using a secure username and password from their locale using their preferred internet enabled hardware (computer, laptop, smartphone, tablet, etc.) to test each Assessee's cognition, as well as to deliver the simulation testing described below with the Administrator (Assessor or HR Representative) 30 at a pre-determined date and time. The fourth alternative is the presently preferred embodiment because it requires no travel or shipment of equipment.

Thus, as a result of the alternatives, each pool of applicants will have a choice of where they would like to be tested, and will normally select a locale most convenient to them. The Proctoring Module delivers a series of brief written tests via the Assessment Center web interface. Each written test may be multiple choice or essay style, and is designed to assess a single or a few aspects of cognition and/or personality/interest (e.g., cognitive/personality/interest “domains”) relative to the compiled Job Model parameters. The collective tests are administered to get an overall ‘picture’ or ‘map’ of an individual's cognitive ability and personality structure relative to all the compiled Job Model parameters. The three most commonly used written tests (and the three most commonly assessed domains of cognition) are attention, memory and executive function. Each Assessee 10 inputs their answers and the results of each cognitive domain test are compiled and attached to the Assessee's individual profile stored in the ASP 20 database.

Presentation of static tests is controlled by a Proctoring Module for delivering queries in hypertext or other software language formats linkable by appropriate Uniform Resource Locators (“URL's”), as the ASP 20 may determine, to a database of learning materials or courseware stored in the ASP 20 database or to other resources or Web sites.

The Proctoring Module is resident on the ASP 20 server and proctors selective tests stored in a database on the ASP 20 server through a remote computer terminal or mobile device such as Smartphone, tablet, or internet enabled device operated at the Assessee 10 locale. There are a variety of commercially-available remote test proctoring software modules suitable for use as the Proctoring Module, including Securexam™ Remote Proctor which proctors distance learning exams remotely.

The dynamic simulations are live, and as shown at step 500, a Simulation Module allows each Assessee 10 to complete simulations in response to live human Assessors 30. The Assessee 10 completes each simulation on video with the same Administrator (Assessor or HR Representative) 30 using the same embodiment discussed above either on a specially-configured portable computer or mobile device such as Smartphone, tablet, or internet enabled device called a Remote Assessment Center Workstation or through the Assessment Center portal (preferred embodiment). This initiates the Simulation Module which launches and records live Simulations delivered to Assessee's 10 using live human administrators in the video simulations (verse taped or staged simulations). Simulations are a type of assessment used to observe behavioral responses to job-related situations. The simulations are relevant to behaviors determined through the Job Model based on its determined behavioral classifications. Specifically, each simulation is designed to elicit a classified behavior appearing in the rendered Job model. Using the above-noted example where a General Manager's Job Model indicates “Leadership” to be a highly ranked behavioral pattern of successful managers and therefore requires a minimum score of 5 for Leadership and an ideal score of 7, a video-recorded simulation will be used which elicits leadership behavior. During the simulation, the person being assessed is evaluated on leadership by an assessor 30. The assessor 30 provides a score using a standardized scale on examples of leadership behavior demonstrated by the Assessee 10 during the simulation.

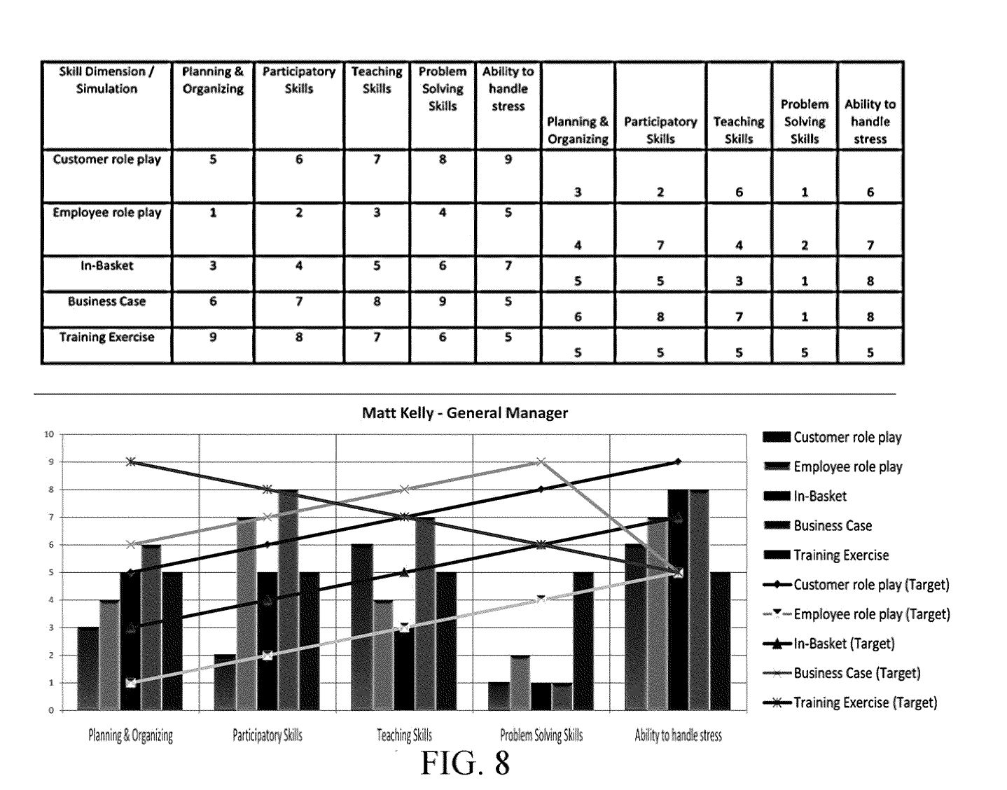

The Simulation Module collects and compiles the scores and plots them against the Job Model threshold data points and acceptable deviations of FIG. 5 (which are in turn derived from the Job Analysis), and an exemplary plot is shown in FIG. 8 (described below). The closeness of actual simulation scores and the threshold data points produces a deviation (i.e. a score of 6 is one unit deviation from “Leadership” to be a highly ranked behavioral pattern of successful managers.

In the present invention, the Assessee simulations are recorded with video using a human administrator and recording software to capture the interactions between the Assessee and Administrator. This is illustrated at FIG. 3(A) top left. Rather than Assessees 10 traveling to the Assessment Center, as described above the Assessee simulations may be deployed either using a specifically configured portable computer (laptop) with webcam, or mobile device such as Smartphone, tablet, or internet enabled device equipped with webcam capabilities. As an example, either the Assessor 30 arrives at the specified locale or the Assessee 10 receives the Remote Assessment Center at their locale. If the latter, they unpack the Remote Assessment Center Workstation, plug in mouse, power cable, network cable, webcam. They turn the laptop on and negotiate a login dialog, entering a password. The Assessment Center portal starts automatically and the Administrator (Assessor or HR Representative) of FIG. 1 sends an instant message or email to confirm start up and launches the Simulation Module resident in the Assessment Center portal. The Simulation Module includes Video Conferencing and Recording (VCR) software for controlling and recording the sessions. The VCR software is generally operative to capture and decode incoming audio and video streams transmitted from the Remote Assessment Center Workstations over a packet switched network, and to append the audio and video stream files to that particular Assessee's individual profile stored in the ASP 30 database. In accordance with embodiments, the Remote Assessment Center Workstations each run a mobile application that presents the Assessor 30 with a user interface complete with camera/microphone controls and that that implements the audio/video encoding and media stream packetization in accordance with International Telecommunication Union (ITU) Packet-Based Multimedia Communications standards. One skilled in the art will readily understand that the above outlined system architecture can also be applied using equivalent mobile display and coding technologies for use on mobile devices. All such devices launch the Assessment Center portal using their internet browser, Assessee 10 logs in, and workflows including the video simulations are conducted using the mobile interface capabilities including webcam.

Typically, an Assessor 30 will conduct a variety of simulation exercises with each Assessee 10. Each simulation is designed to elicit behaviors similar to those expected on the job and to reflect a significant component of the parametric job activities identified in the Job Model. Each simulation exercises only a few dimensions of the Job Model, rather than trying to generally gauge competency.

Examples of preferred simulations include the following:

Simulation #1: In-Basket. This simulates a stress situation, and calls for quick decision-making. The Assessor 30 presents a scenario in which the Assessee 10 is faced with urgent decisions, which must be made within a short time frame. It is the Assessee's 10 responsibility to prioritize the situations which they can handle in the timeframe.

Simulation #2: Listening. The Assessor 30 reads the Assessee 10 instructions in which contra-instructions are provided. For example, Assessor 30 tells the Assessee 10 to interpret a (+) sign as division. The Assessee 10 then solves numerical problems as quickly as possible. This exercises the ability to follow oral instructions.

Simulation #3: Role Plays. The Assessor 30 reads an actual manager/employee situation that may occur on the job, and the Assessor 30 and Assessee 10 act it out. These Role Play situations can emphasize attention on interpersonal skills and creative problem solving.

At step 600, recorded simulation Videos are automatically uploaded to the ASP 20 server and are appended to the Assessee's individual profile stored on the ASP 20 database. The Video Conferencing and Recording (VCR) software module resident on the ASP 20 server runs a backend application to automatically download, decode and store the video/audio clips in this manner. As an example of the above mentioned embodiment, the Assessor closes all open applications and shuts down the Remote Assessment Center Workstations, unplugs and packs up all parts and pieces and places them back into the shipping case. The Remote Assessment Center Workstation is shipped back to either the Supervisor 50, or on to the next destination requested by the Supervisor 50.

At step 700, and as also shown at FIG. 3(B) top right, all Assessors 30-1 . . . n access the Assessment Center portal site and to view the Assessee profile and watch the videos. Note that Assessors 30-1 . . . n will be able to access the portal 24/7 globally to conduct assessments using secure access rights.

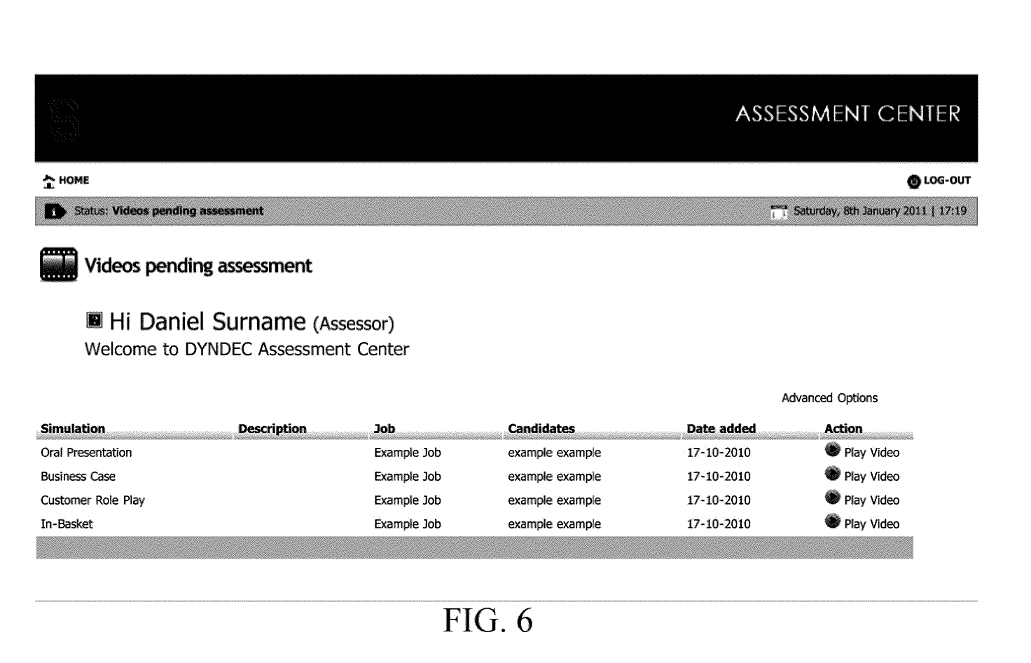

The Assessors 30 are presented with an Assessment Interface that simplifies their reviews. FIG. 6 is a screenshot of the Assessment Interface Homepage which is accessible by Assessors 30-1 . . . n as well as the Assessment Center Supervisor 50, and any other specifically invited guests by secure login. The Assessment Interface Homepage provides a listing of all Assessee 30 candidates assigned to the Assessor, and a list of downloaded simulations for each Assessee 30.

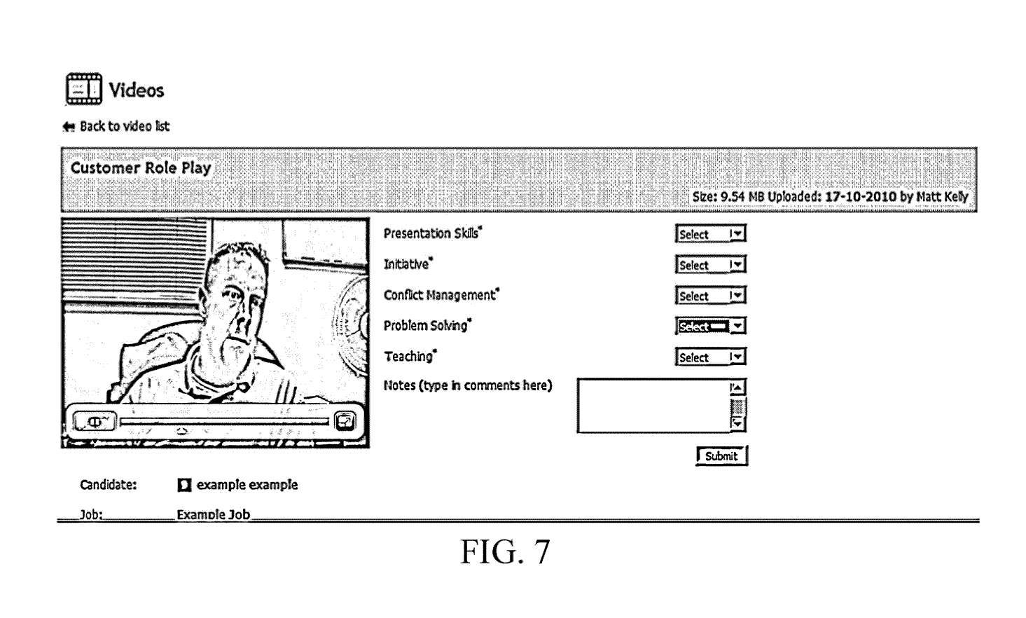

Clicking on a particular Assessee 30 and downloaded simulation such as “example example” engenders the screen shot of FIG. 7, which is the Customer Role Play screen that shows the recorded simulation session for review and facilitates scoring data entry of the Assessor's actual assessment.

The recorded/downloaded Video(s) are presented at left, and a uniform score sheet is presented at right. The Assessor 30 can watch the recorded Video, take free form notes below, and record scores simultaneously. In accordance with the present invention, the Assessors 30-1 . . . n are presented with a common scoring template. Each categorical behavioral parameter in the Job Model is graded by checkboxes indicating highest (10) to lowest (1) performance in that parameter. The submitted grades automatically populate the Job Model Data Point Aggregate Assessor Scores of FIG. 5 (column 3) and Deviation (column 4), and are plotted against the Job Model threshold data points and acceptable deviations of FIG. 5 as shown in FIG. 8 (described below). Thus, at step 800, all Assessors 30-1 . . . n complete scores of Assessee simulations on-line via the Assessment Interface, and their scores are transmitted to the ASP 20 database. This standardized scoring methodology makes the scoring process much less subjective and more reliable. At step 900, Assessor score data is recorded in database. The results are tabulated, and the database data from the Assessor scores are combined with the Assessee 10 scores from their job analysis online testing, and the data is integrated into a statistical model to produce the Assessee performance Data Map, which is a plotted data map of the Assessee's performance data points to the ideal data points of the Job Model.

At step 1000, the combined Assessee data is imported into a consolidated Assessee performance Data Map.

FIG. 8 is an exemplary screenshot of the Assessee performance Data Map. The graphical result shows a probability calculation of success based on the relative closeness of the two sets of data (online testing and simulations). As seen in FIG. 8(top), all of the Assessor 30 scores for each of the delivered video simulation exercises are averaged, tabulated and displayed. Moreover, all of the consolidated Assessor 30 scores for each of the delivered video simulation exercises are plotted as bar charts, each of the (five) sections of the bar chart representing one of the competencies from the job description matrix of drop-down desired behaviors FIG. 4. Within each of the each of the sections of the bar chart the consolidated video simulation scores of the Assessees 30 are plotted in bar chart format, five simulations (described above) having been delivered, scored and plotted accordingly. Additionally, and of great significance, the Job Model threshold data points and acceptable deviations of FIG. 5 (derived by the Simulation Module from the Job Analysis) are plotted as threshold lines above and through the consolidated video simulation scores (bar chart) to provide a readily-apparent visual indication of the threshold target scores and acceptable deviations, and more importantly whether the consolidated video simulation scores (bar chart) meet or exceed the threshold target scores for each of the (five) simulations, and for each individual competency tested by each of the (five) simulations. This particular analytical display of the Assessee performance Data Map provides a centralized picture suitable for collaborative employee selection, promotion, and human resource diagnosis, as well as internal training & development, employee skill enhancement through simulations, and outplacement. Moreover, it forces a standardized scoring methodology and quantitative evaluation that substantially eliminates subjectivity and leads to more reliable outcomes. At step 1100, Reports (including Data Maps) are available for viewing by Assessors 30.

This Data Map becomes the basis for an integration meeting.

At step 1200, Integration Meeting takes place via web conferencing, using a desktop sharing program and conference call phone number. The Integration Meeting is shown in FIG. 3(C). The results of all the Assessor ratings, Reports and Data Maps are shared amongst the Assessors 30, Supervisor 50 and Human Resources or chief decision maker 60. Decisions are made based on the data and group consensus. The foregoing is done entirely online, is tracked within the database, and progress is visually shown in a canned reporting mechanism on-line.

At step 1300, the decision is made.

After the decision is made, at step 1400 the system automatically generates Assessee Reports for each individual Assessee. The reports are appended to each corresponding Assessee Profile in the ASP 20 database and subject to appropriate permissions (secure login) each Assessee 30-1 . . . n may freely login and view their Assessee Report.

The ASP 20 database also include a library of Assessor Training courseware. Thus, when needed, at step 1500, new Assessors can login and undergo online Assessor Training including Videos, online Testing, and other certification steps.

It should now be apparent that the above-described system coordinates the various parties to the Assessment Center methodology, and facilitates information gathering, integration, and analysis, all in an ITFACG-guideline-compliant remote, web-based distributed platform that facilitates selection, assessment, evaluation and promotion of assesses using internet-based technology as a communication vehicle.

The above-described system incorporates traditional Assessment Center processes into a unique workflow and leverages technology to increase speed, flexibility, reduce cost, while maintaining reliability and validity through human administrators and trained assessors. The software-implemented workflow and distributed client-server architecture brings together all principle players in an Assessment Center environment, presents a user-specific and secure graphical interface to each, and provides the shared software tools to implement the Assessment Center workflow in full compliance with ITFACG guidelines. Moreover, the system tracks progress toward fulfillment of the workflow, and generates feedback status reports.

The online web-portal aspect of the system allows for the Customer 40 to provide additional information and services to all of their Assessee's, Assessor's, and other customers. For instance, white papers and service links can be included (regarding the hiring organization including services offered, position in market, etc. as well as information with regard to the assessment process and assessment centers in general.

The above-described embodiment and its alternative deployable uses is for the purpose of promoting an understanding of the principles of the invention. It should nevertheless be understood that no limitation of the scope of the invention is thereby intended, such alternations and further modifications in the illustrated device, and such further applications of the principles of the invention as illustrated herein being contemplated as would normally occur to one skilled in the art to which the invention relates.

We claim:

1. A process for implementing a prescribed Assessment Center workflow and facilitating communications between the primary participants thereof, said primary participants including at least an application service provider, a pool of candidates, an assessor, and a prospective employer, comprising the steps of:
said application service provider providing a hub-and-spoke web-based client/server architecture including a plurality of remote client terminals, a web server in direct communication with all of said client terminals through an Internet backbone, and a database resident on said web server and for storing personal information;
said application service provider subscribing said prospective employer as a client, and providing access to said subscribed client via one or more of said client-terminals to a first URL-based web portal including links to webpage content for guiding the client through said prescribed workflow;
said application service provider providing access to said assessor via a client-terminal to a second URL-based web portal including links to webpage content for guiding the assessor through said prescribed workflow;
said application service provider emailing each of said pool of candidates a link to an assigned URL of said web server;
one of said pool of candidates logging onto their assigned third URL-based web portal including links to webpage content for guiding the candidate through said prescribed workflow;
said candidate completing individual data entry of their own biographical information to thereby become an assessee;
storing said assessee biographical data in said resident database;
said client logging onto their assigned second URL-based web portal and completing data entry into an online job analysis form specifying discrete candidate-selection parameters and importance of each parameter;
said web server automatically executing a job analysis software module to validate said inputted candidate-selection parameters, calculate job skills/competencies, job behaviors, and job dimensions from said candidate-selection parameters, and set behavioral thresholds for each said calculated job skills/competencies, job behaviors, and job dimensions all using a standardized scale;
said assessee logging onto said third assigned URL at the application service provider website and, and completing the following substeps,
completing individual testing,
initiating a video simulation module that automatically establishes a two-way videoconference between said assessee and an assessor, said assessor delivering a video simulation and eliciting one or more of said calculated job skills/competencies, job behaviors, and job dimensions from said candidate-selection parameters, and
recording said video simulation;
displaying said recorded video simulation remotely on said second URL-based web portal along with links to webpage controls for evaluating the assessee in said recorded simulation;
at least one assessor evaluating said assessee through said second URL-based web portal using said webpage controls;
collecting and compiling said simulation scores and individual testing scores and calculating a deviation from said threshold data points of said job analysis;
said web server automatically generating an assessee report quantifying said deviation from said threshold data points of said job analysis; and
communicating said generated assessee report electronically to said client.

2. The process for implementing a prescribed Assessment Center workflow according to claim 1, wherein said step of said web server automatically executing a job analysis software module to validate said inputted candidate-selection parameters, comprises software filtering of candidate-selection parameters not relevant to a given job description.

3. The process for implementing a prescribed Assessment Center workflow according to claim 1, wherein said step of displaying said recorded video simulation comprises displaying said recorded video simulation remotely on said second URL-based web portal to am plurality of assessors, and said plurality of assessors evaluating said assessee through said second URL-based web portal using said webpage controls.

4. The process for implementing a prescribed Assessment Center workflow according to claim 3, wherein said step of collecting and compiling said simulation scores and individual testing scores comprises calculating a statistical deviation from said threshold data points of said job analysis.

5. The process for implementing a prescribed Assessment Center workflow according to claim 4, wherein said one or more of said client-terminals comprise a specially-configured portable computer.

6. The process for implementing a prescribed Assessment Center workflow according to claim 4, wherein said one or more of said client-terminals comprise a mobile device.

7. The process for implementing a prescribed Assessment Center workflow according to claim 4, wherein said one or more of said client-terminals comprise a conventional personal computer.

8. A method for automated assessment for assisting in organizational decision making about different candidates that interface with an organization or educational institution from a central computer server and portal technology, comprising the steps of:
inputting a customer role profile to said computer server;
automatically distilling suitability ranking factors from the customer's role profile using job analysis software resident on said computer server;
conducting online testing of a pool of candidates from remote workstations and mobile applications using web-based proctoring software resident on said computer server;
recording live video simulations of said candidates from remote locations and transmitting recorded simulation videos to said computer server;
displaying said recorded video simulations to a plurality of assessors;
consolidating scores from said online testing and assessors viewing said video simulations into a data map;
displaying said data map to said customer; and
making a collective employment decision from said pool of candidates.

9. The method for automated assessment according to claim 8, wherein said step of inputting a customer role profile to said computer server further comprises the substeps of:
providing a hub-and-spoke web-based client/server architecture including a plurality of remote client terminals, a web server in direct communication with all of said client terminals through an Internet backbone, and a database resident on said web server for storing personal information;
subscribing a prospective employer as a customer;
providing access to said subscribed customer via one or more of said client-terminals to a first URL-based web portal;
providing an online form to said subscribed customer for inputting said customer role profile; and
storing said inputted customer role profile on said computer server.

10. The method for automated assessment according to claim 9, wherein said step of recording live video simulations of said candidates from remote locations further comprises executing a video simulation software module that automatically establishes a two-way videoconference between said assessee and an assessor, allowing said assessor to deliver a video simulation and elicit a plurality of job skills/competencies, job behaviors, and job dimensions from said assessee, and recording said video simulation.

11. The method for automated assessment according to claim 10, wherein said step of recording live video simulations of said candidates from remote locations further comprises executing a video simulation software module that automatically establishes a two-way videoconference between said assessee and an assessor, allowing said assessor to deliver a video simulation and elicit a plurality of job skills/competencies, job behaviors, and job dimensions from said assessee, and recording said video simulation.

12. The method for automated assessment according to claim 10, wherein said step of displaying said recorded video simulations to a plurality of assessors comprises displaying said recorded video simulation remotely on a second URL-based web portal along with links to webpage controls for evaluating the assessee in said recorded simulation.
